(19) United States
(12) Patent Application Publication
(10) Pub. No.: US 2011/0076469 A1
(43) Pub. Date: Mar. 31, 2011

(54) Manufacturing method of optical film, optical film manufactured by the manufacturing method, and polarizing plate and image display having the optical film

(75) Inventors: Hiroyuki Yoneyama, Kanagawa (JP); Yasuyuki Sasada, Kanagawa (JP)

(73) Assignee: FUJIFILM Corporation, Tokyo (JP)

(21) Appl. No.: 12/923,604

(22) Filed: Sep. 29, 2010

(30) Foreign Application Priority Data
Sep. 30, 2009 (JP) 2009-229025

(51) Int. Cl. G02B 5/30; B05D 5/06; B32B 3/10

(52) U.S. Cl. 428/195.1; 427/162; 427/163.1

(57) ABSTRACT

A method for manufacturing an optical film is provided and includes a process of casting two or more dopes containing at least a polymer and a solvent on a base material at the same time, and a process of eliminating the solvent. One dope is a dope (Db) previously containing a dispersed phase at the time of casting or forming a phase-separated dispersed phase in the process of eliminating the solvent. The main component of the solvents constituting the dispersed phase of the dope (Db) is a solvent in which the polymer is substantially insoluble. The dope (Db) is cast to form a contiguous lower layer to a layer on the farthest side from the base material or a layer nearer to the base material than the contiguous lower layer. One different dope (Db) is a dope (Do) not substantially containing a dispersed phase that is phase-separated at the time of casting or in the process of eliminating the solvent, and the dope (Do) not substantially containing a dispersed phase is cast to form a layer on the farthest side from the base material.

This application is based on and claims priority under 35 U.S.C. §119 from Japanese Patent Application No. 2009-229025, filed Sep. 30, 2009, the entire disclosure of which are herein incorporated by reference.

### BACKGROUND OF THE INVENTION

1. Field of the Invention

The present invention relates to a manufacturing method of an optical film, an optical film manufactured by the manufacturing method, and a polarizing plate and an image display having the same.

2. Background Art

Diffusion sheets have been used in various image displays. For example, in a liquid crystal display (LCD), a diffusion sheet is generally arranged between the light source of a backlight and the polarizing plate on the backlight side. By the arrangement of a diffusion sheet, not only uniformity of display characteristic is attained but also interference fringe such as moiré caused by interference of incident light with pixels in the liquid crystals can be restrained from being generated. In recent years, for the purpose of reducing manufacturing costs, it has been tried to decrease the number of members in a liquid crystal display and reduce the number of fluorescent lamps used as light sources with a view to economizing electric power. Further, for the purpose of thinning LCD, the distance between the light source of a backlight and a diffusion sheet is shortened, so that it has been difficult to achieve uniform light diffusion with conventional diffusion films.

For example, there is disclosed in JP-A-2000-75134 a light diffusion polarizing plate having a light diffusion layer possessing prescribed characteristics containing porous amorphous particles and spherical particles as a dispersion, by which a light diffusion sheet can be omitted. JP-A-2001-172403 discloses a manufacturing method of a light diffusion film which comprises casting a dope containing particles on a base material, which patent discloses that a light diffusion film excellent in optical isotropy can be obtained. Further, an optical film having generated bubbles inside the film is disclosed in JP-A-2008-296421.

However, the light diffusion films disclosed in JP-A-2000-75134, JP-A-2001-172403, and JP-A-2008-296421 are not controlled in the surface shapes and backscattering is high ascribing to scattered particles used in the inside of the film or the voids for scattering. Accordingly, all light transmittance is low and there are cases where such films cause lowering of frontal white luminance when they are used in an image display.

Further, when the light diffusion film disclosed in JP-A-2000-75134 is used as a backlight for LCD that is getting thinner, there arises a problem such that breakage of a prism sheet ascribing to the convex shape of surface occurs. In addition, it is necessary to further coat a curable resin layer containing particles on a once formed support, so that further improvement is demanded from productivity.

Further, in the light diffusion film disclosed in JP-A-2001-172403, the support itself contains light diffusion particles and it is necessary to contain a great deal of particles to secure sufficient diffusibility. As a result, brittleness of the film is aggravated or sometimes particles are aggregated with aging from doping to thereby cause deterioration of film quality.

A resin film having a light-scattering property given by forming vacancies in the inside of the support itself and not containing particles for light scattering is disclosed in JP-A-2008-296421. Although the resin film still leaves a problem such that the all light transmittance is low, a certain degree of improvement is seen as to the problems of scratching to a prism sheet and aggravation of film brittleness due to use of light scattering particles in a large amount. However, the manufacturing method of the resin film uses a good solvent and a poor solvent of a film-forming polymer in combination in a dope at the time of film forming, and the poor solvent is phase-separated during evaporation of the good solvent in film-forming process to make a phase-separated phase of the poor solvent, where the polymer is not dissolved, as the voids after film formation. It has been found that the resin film has a problem such that a considerable amount of a poor solvent is used in a dope, so that a good solvent evaporates from the cast dope when a film is continuously formed, and an insoluble matter is adhered to a geeser for extruding the dope to thereby cause streaky failure.

Thus a manufacturing method of an optical film that is simple, inexpensive and excellent in light diffusibility has not yet been realized and further improvement is required.

### SUMMARY OF THE INVENTION

An object of the invention is to solve the above problems and provide a manufacturing method of an optical film that is simple, inexpensive, free from streaky failure and excellent in light diffusibility. Further objects are to provide such an optical film, and a polarizing plate and an image display having the optical film.

The above objects can be solved by the following constitutions.

(1) A method for manufacturing an optical film, comprising: casting two or more dopes on a base material simultaneously, each dopes containing at least a polymer and a solvent; and eliminating the solvent,

wherein

at least one dope is a dope (Db) that already contains a dispersed phase at a time of the casting or that forms a phase-separated dispersed phase in the eliminating the solvent after the casting;

the dope (Db) contains a main component of the solvent constituting the dispersed phase, the main component being a solvent in which the polymer is substantially insoluble;

the dope (Db) is cast to form a contiguous lower layer to a layer on the farthest side from the base material of the optical film or a layer nearer to the base material than the contiguous lower layer, at the time of the casting;

at least one dope different from the dope (Db) is a dope (Do) not substantially containing a dispersed phase that is phase-separated at the time of the casting or in the eliminating the solvent after the casting, and

the dope (Do) not substantially containing a dispersed phase is cast to form a layer on the farthest side from the base material of the optical film at the time of the casting.

(2) The method for manufacturing an optical film as described in (1), wherein the dope (Do) not substantially containing a dispersed phase is cast at the time of the casting to form a layer nearest to the base material of the optical film.
(3) The method for manufacturing an optical film as described in (1) or (2), wherein the solvent contained in at least one of the dope (Db) is a mixed solvent containing two or more solvents and at least one solvent of the two or more solvents has a dielectric constant of 35 or more, and at least two solvents of the mixed solvent are solvents hardly compatible with each other.
(4) The method for manufacturing an optical film as described in (3), wherein the mixed solvent contained in at least one of the dope (Db) is a mixed solvent containing a solvent having a dielectric constant of 35 or more in an amount of from 0.3% by mass to 30% by mass.
(5) The method for manufacturing an optical film as described in (3) or (4), wherein the mixed solvent contained in at least one of the dope (Db) contains a solvent having a dielectric constant of 2 or more and less than 10, and a solvent having a dielectric constant of 10 or more and less than 35.
(6) The method for manufacturing an optical film as described in any one of (3) to (5), wherein the solvent having a dielectric constant of 35 or more is water.
(7) The method for manufacturing an optical film as described in (1) or (2), wherein the solvent contained in at least one of the dope (Db) is a mixed solvent containing two or more solvents and at least one solvent of the two or more solvents has a dielectric constant of 2 or more and less than 10, and at least other one solvent has a dielectric constant of 10 or more and less than 35.
(8) The method for manufacturing an optical film as described in any one of (1) to (7), wherein the polymer contained in at least one of the dope (Db) is cellulose acylate.
(9) An optical film manufactured by a manufacturing method as described in any one of (1) to (8).
(10) The optical film as described in (9), which has a haze of 3% or more and 95% or less.
(11) A polarizing plate comprising a polarizing film and two protective films on both sides of the polarizing film, wherein at least one of the protective films is an optical film as described in (9) or (10).
(12) An image display having at least one of an optical film as described in (9) or (10) and a polarizing plate as described in (11).

### DETAILED DESCRIPTION OF THE INVENTION

According to an exemplary embodiment of the invention, it is possible to provide a manufacturing method of an optical film that is simple, inexpensive, free from streaky failure and excellent in light diffusibility. Further, An optical film of the invention or an image display using a polarizing plate having the optical film can control interference fringe such as moiré. The optical film can contribute to the improvement of displaying ability and thinning of an image display such as a liquid crystal display.

Exemplary embodiments of the invention will be described in detail below, but the invention is by no means restricted thereto. Incidentally, in the specification, when numerical values represent physical values and characteristic values, the description “from (numerical value 1) to (numerical value 2)” means “numerical value 1 or more and numerical value 2 or less”.

### [Optical Film]

An optical film in the invention manufactured by the manufacturing method of the invention is an optical film containing the polymer and having cavities (concavities) on the surface of the film and a light scattering property attributable to the surface form.

In the optical film in the invention, a dispersed phase of a dope (Db) is immobilized in a film at the time of film forming and a solvent for forming the dispersed phase is finally evaporated to form voids free of a polymer in the film, by which the film shows characteristic light scattering behavior.

The manufacturing method of the optical film in the invention is to solve such a problem that a dispersed phase low in solubility in a continuous phase is adhered to a casting geeser as an insoluble matter in manufacturing the optical film to cause a streaky failure. The manufacturing method is a method of using, when two or more dopes are co-cast, a dope (Db) containing a dispersed phase or forming a dispersed phase in the process of eliminating a solvent after casting to form a contiguous lower layer to a layer on the farthest side from the cast base material or a layer nearer to the base material than the contiguous lower layer, and using a dope (Do) not containing a dispersed phase to form a layer on the farthest side from the case base material.

The dispersed phase where the polymer in the dope is not substantially dissolved means a discontinuous dispersed phase of a size of a degree capable of scattering the light in a visible light region in a continuous phase of a dope. The dispersed phase is a liquid not a gas or a solid. The dispersed phase consists of a solvent having low solubility of a polymer and there are cases where a low molecular weight additive in the dope is contained. It is not easy to directly detect a dispersed phase itself and find the content of the polymer present therein is not easy, but the solubility of a polymer in a primary solvent constituting a dispersed phase is preferably 1 g or less per 100 g of the solvent, and more preferably 0.1 g or less, or the polymer may be insoluble. Here, the primary solvent constituting a dispersed phase means a solvent of the highest content in the dispersed phase.

The formation of a dispersed phase can be evaluated by using the haze of the solution of dope. When a dispersed phase is formed, the haze of the solution of dope is preferably 0.2 to 50% or so as measured with a quartz cell having an optical path length of 1 cm, and more preferably 0.2 to 30%. When the haze of the dope to be used in casting is in the above range, aging stability of the dope is secured and failure by foreign matters at film forming time can be decreased. Whether a dispersed phase can be formed or not by the evaporation of a solvent from a dope at film forming time can be judged from the presence or absence of significant rising of haze with a dope prepared by removing a low boiling temperature solvent from a dope which is completely dissolved and substantially free from haze, or by intentionally reducing a low boiling temperature solvent.

In the optical film in the invention, voids may be present in a closed state inside the film, may be present as opened voids (cavities) on the film surface, or both may coexist. Since an optical film containing closed voids inside the film is low in the refractive index of the voids (that of air is 1.0), the difference in refractive index from the film itself is great, and the film is an optical film high in the backscattering and low in all light transmittance. Further, an optical film containing opened voids (cavities) on the surface shows a light scattering property based on the surface shape consisting of flat parts and concave parts, and the film becomes an optical film having high all light transmittance, although the haze is high. In the invention, haze is preferably 3% to 95%, more preferably 15% to 95%, still more preferably 30% to 90%, and most preferably 50% to 90%. The all light transmittance of a film containing opened voids is preferably 75% to 95% and more preferably 80% to 93%.

### [Manufacturing Method of an Optical Film]

The manufacturing method of an optical film of the invention comprises a process of casting two or more dopes containing at least a polymer and a solvent on a base material at the same time, and a process of eliminating the solvent.

At least one dope is a dope (Db) previously containing a dispersed phase at the time of casting or forming a phase-separated dispersed phase in the process of eliminating the solvent after casting.

The main component of the solvents constituting the dispersed phase of the dope (Db) is a solvent in which the polymer is substantially insoluble. The dope (Db) is cast to form a contiguous lower layer to a layer on the farthest side from the base material of the optical film or a layer nearer to the base material than the contiguous lower layer, at the time of casting the dope.

At least one dope different from the dope (Db) is a dope (Do) not substantially containing a dispersed phase that is phase-separated at the time of casting or in the process of eliminating the solvent after casting.

The dope (Do) not substantially containing a dispersed phase is cast to form a layer on the farthest side from the base material of the optical film at the time of casting the dope.

### [Dope]

The manufacturing method of an optical film of the invention comprises a process of casting two or more dopes containing at least a polymer and a solvent on a base material at the same time.

At least one of the dopes is a dope (Db) previously containing a dispersed phase at the time of casting or forming a phase-separated dispersed phase in the process of eliminating the solvent after casting, and at least one different dope is a dope (Do) not substantially containing a dispersed phase that is phase-separated at the time of casting or in the process of eliminating the solvent after casting.

It is preferred from the viewpoint of aging stability of a dope and planar stability of an optical film formed with the dope that a polymer is dissolved in a solvent in every dope in the invention and homogeneous as a whole. In the dope (Db), polymers are not dissolved in dispersed phases but it is preferred for polymers to be homogeneously dissolved in solvents other than dispersed phases.

### [Dope (Db)]

The dope (Db) is a dope previously containing a dispersed phase at the time of casting or forming a phase-separated dispersed phase in the process of eliminating the solvent after casting. The main component of the solvents constituting the dispersed phase of the dope (Db) is a solvent in which the polymer is substantially insoluble. Here, the main component of the solvents constituting the dispersed phase means a component highest in mass ratio of the solvents constituting the dispersed phase. Further, “the polymer is substantially insoluble” means that the mass of the polymer soluble in 100 g of a solvent at 20° C. is less than 1 g.

For manufacturing such a dope (Db), it is preferred to use a mixed solvent containing two or more solvents as the solvent to be contained in the dope (Db), the dielectric constant of at least one solvent of the two or more solvents is 35 or more, and at least two solvents of the mixed solvent are hardly compatible. “Hardly compatible” means that two solvents do not mix by an arbitrary ratio at 20° C. For example, water and dichloromethane are hardly compatible, but water and methanol, and dichloromethane and methanol are completely compatible.

By the use of the dope (Db), a film whose surface shape is properly controlled can be manufactured. Since a polymer solution (a dope) is conventionally manufactured with solvents compatible with each other, a film free of cavities on the surface thereof is formed in many cases, and even when cavities are formed on the surface by adjusting the compositions of solvents, the formed film also has voids inside the film. With such a film, the difference in refractive index between the materials forming the film and the air (refractive index: 1.0) in the voids is great, so that wide-angle scattering in the void parts becomes great and backscattering is liable to occur. In a film having such voids inside, backscattering increases with rising of haze and all light transmittance lowers, and a haze value cannot be reconciled with all light transmittance in a preferred range. In the invention, a film having minute cavities on the surface can be obtained by using the dope (Db). Incidentally, the optical film in the invention also has a characteristic such that the inside void ratio of a film is low. Specifically the inside void ratio of the film is preferably 10% or less (volume ratio), more preferably 5% or less, and especially preferably 3% or less.

### [Solvent Having Dielectric Constant of 35 or More]

It is preferred to use a solvent containing 0.3% by mass or more of a solvent having a dielectric constant of 35 or more (hereinafter referred to as “a high dielectric constant solvent”) in the dope (Db), by which the surface shape of a film can be more properly controlled. It is more preferred to use a solvent containing 1.0% by mass or more of a high dielectric constant solvent, and further it is preferred to use a solvent containing 1.5% by mass or more of a high dielectric constant solvent. On the other hand, when the ratio of a high dielectric constant solvent is too high, polymer is dissolved with difficulty and preparation of a polymer solution is difficult, and further, such problems arise that, even if a polymer solution can be prepared, the haze of the obtained dope is high, aging stability of the dope worsens, or foreign matters in a film increase. In this point of view, the content of a high dielectric constant solvent is preferably 30% by mass or less, and more preferably 10% by mass or less. By forming a film with a polymer solution prepared by the use of a solvent containing a high dielectric constant solvent in a prescribed range, it is presumed that phase separation occurs in the solution between the polymer and the high dielectric constant solvent at the time of film forming or when the solvent is evaporated after film forming. As a result, such minute cavities on the surface of the film as the optical film of the invention has can be more easily obtained. Further, in view of effectively forming minute cavities of the surface, the boiling temperature of a high dielectric constant solvent is preferably higher than the boiling temperature of the later-described low boiling temperature solvent, more preferably higher by 5° C. or more, and still more preferably higher by 10° C. or more, and it is preferred that both are not azeotropic.

The dielectric constant of a solvent is described. Dielectric constant is c for giving D=∈E, relationship of dielectric flux D and electric field E, which is a parameter having easiness of polarization of a solvent molecule and correlation. The values of dielectric constant of solvents are described as “specific inductive capacity” in, for example, compiled by Nippon Chemical Society, Chemical Handbook, Elementary Course I, Revised 5^{th} Edition, page 1-770.

The examples of high dielectric constant solvents include water (dielectric constant: 78), glycerol (dielectric constant: 43), ethylene glycol (dielectric constant: 37), dimethylformamide (dielectric constant: 37), acetonitrile (dielectric constant: 38), dimethyl sulfoxide (dielectric constant: 49), formic acid (dielectric constant: 58), and formamide (dielectric constant: 110). Of these solvents, from handling point of view such as a drying property and safety in the manufacturing process, water is preferred. From the viewpoint of surface shape control at film-forming time, the boiling temperature of high dielectric constant solvents is preferably 70° C. to 300° C., more preferably 80° C. to 250° C., and most preferably 90° C. to 210° C.

### [Primary Solvent]

It is preferred to use an organic solvent which is a good solvent of at least one polymer as the primary solvent together with a high dielectric constant solvent. The primary solvent is a solvent that is the highest in the proportion of content among the solvents. The kinds of primary solvents are not especially restricted, but it is preferred that primary solvents are not compatible with the above high dielectric constant solvents. When the high dielectric constant solvent and the primary solvent of a polymer alone are used and solvents other than the primary solvent of a polymer are not used, it is necessary that the primary solvent of a polymer is a solvent not compatible with the high dielectric constant solvent. Organic solvents having a boiling temperature of 80° C. or less are more preferred as primary solvents from the point of drying load reduction. The boiling temperature of the primary solvent is more preferably 10° C. to 80° C., and especially preferably 20° C. to 60° C. According to cases, organic solvents having a boiling temperature of 30° C. to 45° C. can also be preferably used as the primary solvent. As such primary solvents, halogenated hydrocarbons can be especially preferably exemplified, and esters, ketones, ethers, alcohols and hydrocarbons can also be exemplified depending upon cases. These compounds may have a branched structure or a cyclic structure. The primary solvents may have any two or more of the functional groups of esters, ketones, ethers and alcohols (i.e., —O—, —CO—, —COO— and —OH). Further, the hydrogen atoms in the hydrocarbon parts of the above esters, ketones, ethers and alcohols may be substituted with a halogen atom (especially, a fluorine atom). When the solvent in the polymer solution for use in the manufacturing method of the invention consists of a single solvent, the solvent is a primary solvent, and when a plurality of solvents are used, the solvent of the highest content by mass among the constituting solvents is a primary solvent.

As the organic solvents used in combination with these primary solvents, halogenated hydrocarbons, esters, ketones, ethers, alcohols and hydrocarbons can also be exemplified besides the above high dielectric constant solvents, which solvents may have a branched structure or a cyclic structure. The organic solvents may have any two or more of the functional groups of esters, ketones, ethers and alcohols (i.e., —O—, —CO—, —COO— and —OH). Further, the hydrogen atoms in the hydrocarbon parts of the above esters, ketones, ethers and alcohols may be substituted with a halogen atom (especially, a fluorine atom). Further, when the primary solvent of the polymer is a solvent compatible with the high dielectric constant solvent, it is necessary in the invention that the organic solvent used in combination with the primary solvent is a solvent not compatible with the high dielectric constant solvent.

As the halogenated hydrocarbons, chlorinated hydrocarbon is more preferred and, for example, dichloromethane and chloroform are exemplified, and dichloromethane is more preferred.

As the esters, e.g., methyl formate, ethyl formate, propyl formate, pentyl formate, methyl acetate, ethyl acetate, and pentyl acetate are exemplified.

As the ketones, e.g., acetone, methyl ethyl ketone, diethyl ketone, diisobutyl ketone, cyclopentanone, cyclohexanone, and methyl cyclohexanone are exemplified.

As the ethers, e.g., diethyl ether, methyl-tert-butyl ether, diisopropyl ether, dimethoxymethane, dimethoxyethane, 1,4-dioxane, 1,3-dioxolan, 4-methyldioxolan, tetrahydrofuran, methyltetrahydrofuran, anisole and phenetole are exemplified.

As the alcohols, e.g., methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol, and 2,2,3,3-tetrafluoro-1-propanol are exemplified.

As the hydrocarbons, e.g., n-pentane, cyclohexane, n-hexane, benzene and toluene are exemplified.

When the polymer as the main component is cellulose acylate, it is preferred to use a mixed solvent comprising a solvent having a dielectric constant of 10 to less than 35 (hereinafter sometimes referred to as “a medium dielectric constant solvent”) and a solvent having a low dielectric constant of 2 to less than 10 (hereinafter sometimes referred to as “a low dielectric constant solvent”), of the above solvents, together with the high dielectric constant solvent, since a highly transparent polymer solution can be stably prepared. That is to say, from the viewpoint of surface shape control, it is preferred to use the high dielectric constant solvent and from the point of improvement of solubility of the polymer, the low dielectric constant solvent is preferably used, but these solvents are bad in compatibility and stability of the dope is inferior. Therefore, by the use of the medium dielectric constant solvent in combination, the compatibility can be improved, the range of reconciliation of surface shape control of the film and stability of the dope can be extended, and an aptitude for manufacture can be improved. The medium dielectric constant solvent is preferably contained in proportion of 0.3% by mass to 30% by mass in a mixed solvent, more preferably 1% by mass to 15% by mass, and still more preferably 2% by mass to 10% by mass. The low dielectric constant solvent is preferably contained in proportion of 40% by mass to 99.5% by mass in a mixed solvent, more preferably 60% by mass to 99% by mass, and especially preferably 70% by mass to 98% by mass.

The examples of the medium dielectric constant solvents include the alcohols, ketones and ethers. Specifically the examples include acetone (dielectric constant: 21), methyl ethyl ketone (dielectric constant: 19), diethyl ketone (dielectric constant: 14), diisobutyl ketone (dielectric constant: 15), cyclopentanone (dielectric constant: 19), cyclohexanone (dielectric constant: 18), methyl cyclohexanone (dielectric constant: 18), ethyl 2-ethoxyacetate (dielectric constant: 11), 2-methoxyethanol (dielectric constant: 30), 1,2-diacetoxyacetone (dielectric constant: 16), acetylacetone (dielectric constant: 17), ethyl acetoacetate (dielectric constant: 16), methanol (dielectric constant: 33), ethanol (dielectric constant: 24), 1-propanol (dielectric constant: 22), 2-propanol (dielectric constant: 22), 1-butanol (dielectric constant: 17), 2-butanol (dielectric constant: 16), tert-butanol (dielectric constant: 11), 1-pentanol (dielectric constant: 14), 2-methyl-2-butanol (dielectric constant: 13), and cyclohexanol (dielectric constant: 15).

The examples of the low dielectric constant solvents include the halogenated hydrocarbons and esters. Specifically the examples include dichloromethane (dielectric constant: 9), dimethoxyethane (dielectric constant: 6), 1,4-dioxane (dielectric constant: 2), 1,3-dioxolan (dielectric constant: 3), 1,3,5-trioxane (dielectric constant: 3), tetrahydrofuran (dielectric constant: 8), anisole (dielectric constant: 4), phenetole (dielectric constant: 4), ethyl formate (dielectric constant: 9), n-propyl formate (dielectric constant: 6), n-pentyl formate (dielectric constant: 6), methyl acetate (dielectric constant: 7), ethyl acetate (dielectric constant: 6), n-pentyl acetate (dielectric constant: 5), and 2-butoxyethanol (dielectric constant: 9).

Of these solvents, mixed solvents consisting of water, at least one of alcohols and at least one of halogenated hydrocarbons are preferred, and mixed solvents consisting of water in proportion of 0.3% by mass to 30% by mass, at least one of alcohols in proportion of 1% by mass to 30% by mass, and at least one of halogenated hydrocarbons in proportion of 60% by mass to 99% by mass are more preferred. A mixed solvent consisting of water (dielectric constant: 78), methanol (dielectric constant: 33) and dichloromethane (dielectric constant: 9) is especially preferred. From the viewpoint of haze increase of the film, the water content is the more the better, but considering the solubility of the polymer and the film-forming properties such as the visco-elastic characteristic of the polymer solution, the water content is more preferably 0.5% by mass to 10% by mass, and still more preferably 1% by mass to 5% by mass. Also, from the viewpoint of haze increase of the film, the content of alcohol is the less the better, but considering the solubility of the polymer and the film-forming properties such as the reduction of streaky failure occurring on the film with long-run use, the alcohol content is more preferably 3% by mass to 20% by mass, and still more preferably 5% by mass to 10% by mass. The preferred range of the total ratio of the solvents other than the primary solvent is, as combination of these solvents, preferably 0.8% by mass to 40% by mass, and more preferably 2% by mass to 35% by mass.

In the optical film in the invention, for providing voids not only on the surface of the optical film but also inside the optical film, it is also possible to use in combination of a medium dielectric constant solvent having a dielectric constant of 10 to less than 35 and a low dielectric constant solvent having a low dielectric constant of 2 to less than 10 and not containing a high dielectric constant solvent as the dope (Db) for forming a dispersed phase. The proportion of the medium dielectric constant solvent to all the solvents is preferably 20% by mass to 90% by mass and more preferably 20% by mass to 50% by mass, considering the easiness of formation of concavities and precipitation of the dope in the conveying process. The proportion of the low dielectric constant solvent to all the solvents is preferably 10% by mass to 80% by mass and more preferably 50% by mass to 80% by mass.

By providing voids inside the optical film, scattering of film inside can be provided in addition to light scattering due to surface shape. When a light scattering property is given only by the surface shape of the film, if other functional group and adhesive layer are further provided, the surface shape changes by the influences of these layers and the light scattering property is liable to change. It is possible to reduce these influences by giving a light scattering property also to the inside of the optical film.

On the other hand, since the difference in refractive index between the void and the polymer forming the film is big as to the inside void, backscattering becomes large and reduction of all light transmittance is liable to occur. Therefore, when the optical film is used in an image display and the like making much account of contrast, it is preferred not to use more inside voids than necessary.

### [Polymer]

Polymers contained in a dope are described below. It is preferred that a polymer is a primary component (the material having the proportion of 51% by mass or more and 100% by mass or less of the solid content of the optical film) constituting the optical film of the invention, and a thermoplastic resin is preferably used. The specific examples include cellulose acylate (e.g., triacetyl cellulose (cellulose triacetate), diacetyl cellulose, propionyl cellulose, butyryl cellulose, acetylbutyryl cellulose (cellulose acetate butyrate), acetylpropionyl cellulose, and nitrocellulose), polyamide, polycarbonate, polyester (e.g., polyethylene terephthalate, polyethylene naphthalate, poly-1,4-cyclohexanedimethylene terephthalate, polyethylene-1,2-diphenoxyethane-4,4′-dicarboxylate, and polybutylene terephthalate), polystyrene (e.g., syndiotactic polystyrene), polyolefin (e.g., polypropylene, polyethylene, polymethylpentene, and polycycloalkane), polysulfone, polyether sulfone, polyallylate, polyether imide, polymethyl methacrylate, polyether ketone, norbornene resin (Arton, trade name, manufactured by JSR Corporation), amorphous polyolefin (Zeonex, trade name, manufactured by ZEON Corporation), and (meth)acrylic resin (Acrypet VRL20A, trade name, manufactured by Mitsubishi Rayon Co., Ltd., and acrylic resins containing a cyclic structure as disclosed in JP-A-2004-70296 and JP-A-2006-171464). Of these polymers, triacetyl cellulose, diacetyl cellulose, acetylbutyryl cellulose, propionyl cellulose, polycarbonate, and modified polymethyl methacrylate are preferred, and triacetyl cellulose, acetylbutyryl cellulose and polycarbonate are especially preferred.

When the optical film in the invention is used as the protective film of a polarizing plate, balance of hydrophobicity/hydrophilicity of the film, laminating property with vinyl alcohol films of the polarizing plate and uniformity of entire inplane optical characteristics of the film are important, and fatty acid ester of cellulose (cellulose acylate) is especially preferred, and triacetyl cellulose, diacetyl cellulose, acetylbutyryl cellulose and propionyl cellulose are preferably used.

Usable cellulose acylates are further described below.

As celluloses which are the raw materials of cellulose acylate films, cotton linter, kenaf, and wood pulp (hardwood pulp and softwood pulp) are exemplified, and cellulose esters obtained from any of these raw material celluloses can be used, and mixture thereof may be used, if necessary.

Cellulose acylate is ester of cellulose and carboxylic acid. In the above cellulose acylates, all or a part of the hydrogen atoms of the hydroxyl groups present on the 2-, 3- and 6-positions of glucose units constituting the celluloses are substituted with an acyl group. The number of carbon atoms of the acyl group is preferably 2 to 22, and more preferably 2 to 4. The examples of the acyl groups include an acetyl group, a propionyl group, a butyryl group, an isobutyryl group, a pivaloyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, a cyclohexanecarbonyl group, an oleoyl group, a benzoyl group, a naphthylcarbonyl group, and a cinnamoyl group. Of these acyl groups, an acetyl group, a propionyl group, a butyryl group, a dodecanoyl group, an octadecanoyl group, a pivaloyl group, an oleoyl group, a benzoyl group, a naphthylcarbonyl group, and a cinnamoyl group are preferred, and an acetyl group, a propionyl group and a butyryl group are most preferred.

Cellulose acylate may be ester of cellulose and a plurality of carboxylic acids. That is, cellulose acylate may be substituted with a plurality of acyl groups.

When the degree of substitution of acetyl groups (having 2 carbon atoms) substituted on the hydroxyl groups of the cellulose of cellulose acylate is taken as SA, and the degree of substitution of acyl groups having 3 or more carbon atoms substituted on the hydroxyl groups of the cellulose is taken as SB, haze of the cellulose acylate film manufactured according to the manufacturing method of the invention can be adjusted by adjusting SA and SB.

SA+SB is arbitrarily adjusted depending upon the haze to be asked to the cellulose acylate film manufactured according to the manufacturing method of the invention, which is the optical film in the invention, and SA+SB is preferably 2.70<SA+S≦3.00, more preferably 2.80≦SA+S≦3.00, and still more preferably 2.85≦SA+S≦2.90. Haze is liable to be higher by making SA+SB larger.

Further, haze of the cellulose acylate film manufactured according to the manufacturing method of the invention can also be adjusted by adjusting SB. By making SB larger, haze is liable to be higher and at the same time the modulus of elasticity and melting temperature of the film lower. Considering the balance of haze of the film with other physical properties, the range of SB is preferably 0≦SB≦2.9, more preferably 0.5≦SB≦2.5, and still more preferably 1≦SB≦2.0. Incidentally, when all the hydroxyl groups of cellulose are substituted, the degree of substitution is 3.

Synthesizing methods of cellulose acylate are described in detail in Hatsumei Kyokai Kokai Giho Kogi No. 2001-1745 (published by Hatsumei Kyokai, Mar. 15, 2001), pp. 7-12, and these methods can be referred to.

The concentration of the polymer in a dope is preferably 5% by mass to 40% by mass to all the components in the dope, more preferably 10% by mass to 25% by mass, and still more preferably 10% by mass to 20% by mass. When the concentration is in the preferred range, the film-forming property is improved and streaky failure occurring on the film with long-run use can be preferably reduced.

### [Plasticizer]

Plasticizers may be used in the invention for the purpose of giving flexibility to the optical film, improving dimensional stability and humidity resistance of the film.

As plasticizers for the optical film, plasticizers having an octanol/water distribution coefficient (logP value) of 0 to 10 are especially preferably used. When the logP value of a compound is 10 or less, compatibility with the polymer is good and malfunctions such as clouding and powdering of the film can be prevented from occurring. While when the logP value is 0 or more, hydrophilicity does not rise excessively and an evil such as degradation of water resistance of the polymer is difficultly caused, so that it is preferred to use plasticizers falling in the above range. The more preferred range of logP value is 1 to 8, and especially preferred range is 2 to 7.

The octanol/water distribution coefficient (logP value) can be measured by the flask shaking method described in Japanese Industrial Standards (JIS) Z7260-107 (2000). It is also possible to estimate the octanol/water distribution coefficient (logP value) according to a computing chemical method or an empirical method in place of actual measurement. As computing methods, Crippen's fragmentation method (J. Chem. Inf. Comput. Sci., Vol. 27, p. 21 (1987)), Viswanadhan's fragmentation method (J. Chem. Inf. Comput. Sci., Vol. 29, p. 163 (1989)), Broto's fragmentation method (Eur. J. Med. Chem.—Chim. Theor., Vol. 19, p. 71 (1984)) and the like are preferably used, and Crippen's fragmentation method is more preferably used of these methods. When the logP value of a certain compound differs depending upon the methods of measurement or computation, whether the compound is within the scope of the invention or not is preferably judged by Crippen's fragmentation method.

As preferably added plasticizers, low molecular weight oligomer compounds within the above range of physical properties and having a molecular weight of 190 to 5,000 or so, e.g., phosphoric esters, carboxylic esters, polyol esters and the like are exemplified.

The examples of the phosphoric esters include triphenyl phosphate (TPP), tricresyl phosphate, cresyl diphenyl phosphate, octyl diphenyl phosphate, biphenyl diphenyl phosphate, trioctyl phosphate, tributyl phosphate, and the like, and preferred of these are triphenyl phosphate and biphenyl diphenyl phosphate.

As the carboxylic esters, phthalic esters and citric esters are representative. The examples of the phthalic esters include dimethyl phthalate, diethyl phthalate, dibutyl phthalate, dioctyl phthalate, diphenyl phthalate, diethylhexyl phthalate, and the like. The examples of the citric esters include triethyl O-acetyl citrate, tributyl O-acetyl citrate, acetyl triethyl citrate, acetyl tributyl citrate, and the like.

These preferred plasticizers except for TPP (melting temperature: about 50° C.) are liquids at 25° C., and boiling temperature is also 250° C. or higher.

The examples of other carboxylic esters include butyl oleate, methylacetyl ricinoleate, dibutyl sebacate, and various kinds of trimellitic esters. As the examples of glycolic esters, triacetin, tributyrin, ethyl phthalyl ethyl glycolate, methyl phthalyl ethyl glycolate, butyl phthalyl butyl glycolate, methyl phthalyl methyl glycolate, propyl phthalyl propyl glycolate, octyl phthalyl octyl glycolate, and the like are exemplified.

Plasticizers disclosed in JP-A-5-194788, JP-A-60-250053, JP-A-4-227941, JP-A-6-16869, JP-A-5-271471, JP-A-7-286068, JP-A-5-5047, JP-A-11-80381, JP-A-7-20317, JP-A-8-57879, JP-A-10-152568, and JP-A-10-120824 are also preferably used. There are many preferred descriptions in these patent publications concerning the utilizing methods and characteristics of plasticizers, in addition to the examples of plasticizers, and these can also be preferably used in the invention.

As other plasticizers, (di)pentaerythritol esters as disclosed in JP-A-11-124445, glycerol esters as disclosed in JP-A-11-246704, diglycerol esters as disclosed in JP-A-2000-63560, citric esters as disclosed in JP-A-11-92574, substituted phenylphosphoric esters as disclosed in JP-A-11-90946, and esterified compounds having an aromatic ring and a cyclohexane ring as disclosed in JP-A-2003-165868 are preferably used.

Polymer plasticizers having a resin component having a molecular weight of 1,000 to 100,000 are also preferably used. For example, polyesters and polyethers as disclosed in JP-A-2002-22956, polyester ethers, polyester urethanes or polyesters as disclosed in JP-A-5-197073, copolyester ethers as disclosed in JP-A-2-292342, and epoxy resins and novolak resins as disclosed in JP-A-2002-146044 are exemplified.

These plasticizers may be used by one kind alone or two or more may be used as mixture. The addition amount of plasticizers is preferably 2 parts by mass to 30 parts by mass per 100 parts by mass of the polymer, and especially preferably 5 parts by mass to 20 parts by mass. Further, when a dope forming a dispersed phase and a dope not forming a dispersed phase are contiguously co-cast, it is preferred to use a plasticizer having a structure common to the dopes of both layers, since generation of turbulence of the dopes in casting at the interface lessens, and excellent adhesion in the film of the optical film is attained.

### [Ultraviolet Absorber]

It is preferred to further add an ultraviolet absorber (an ultraviolet preventive) to the optical film of the invention for the purpose of the improvement of light fastness of the film itself, or deterioration prevention of the polarizing plate and image display members such as the liquid crystal compounds of the liquid crystal display.

As the ultraviolet absorbers, it is preferred to use ultraviolet absorbers excellent in absorbing ability of ultraviolet rays of wavelength 370 nm or less in view of deterioration prevention of liquid crystals, and little in absorption of visible rays of wavelength 400 nm or more as far as possible from the point of good image displaying performance. In particular, transmittance at wavelength 370 nm is desirably 20% or less, preferably 10% or less, and more preferably 5% or less. As such ultraviolet absorbers, e.g., oxy benzophenone compounds, benzotriazole compounds, salicylic ester compounds, benzophenone compounds, cyano acrylate compounds, nickel complex salt compounds, and polymeric ultraviolet absorbing compounds containing the ultraviolet absorbing groups are exemplified, but the invention is not restricted thereto. Ultraviolet absorbers may be used in combination of two or more.

The use amount of ultraviolet absorbers in the invention is 0.1 parts by mass to 5.0 parts by mass to 100 parts by mass to the polymer for use in the optical film, preferably 0.5 parts by mass to 4.0 parts by mass, and more preferably 0.8 parts by mass to 2.5 parts by mass. Further, when a dope forming a dispersed phase and a dope not forming a dispersed phase are contiguously co-cast, it is preferred to use an ultraviolet absorber having a structure common to the dopes of both layers, since generation of turbulence of the dopes in casting at the interface lessens, and excellent adhesion in the film of the optical film is attained.

The optical film in the invention may contain additives with one or two or more primary raw material polymers. The examples of such additives include a plasticizer (preferred addition amount is 0.01% by mass to 30% by mass to the polymers, hereinafter the same), an ultraviolet absorber (0.001% by mass to 1% by mass), a fluorine surfactant (0.001% by mass to 1% by mass), a release agent (0.0001% by mass to 1% by mass), a deterioration preventive (0.0001% by mass to 1% by mass), an optical anisotropy controlling agent (0.01% by mass to 10% by mass), and an infrared absorber (0.001% by mass to 1% by mass). Particles comprising a trace amount of an organic material, inorganic material or mixture thereof may be contained as dispersion within the range not impairing the advantage of the invention. When these particles are added for the purpose of improving the conveyance of the film at film-forming time, the particle size is preferably 5 nm to 3,000 nm, and the addition amount is preferably 1% by mass or less. When particles for giving a light scattering property to film inside are added as assistant, the particle size is preferably 1 μm to 20 μm and the addition amount is preferably 2% by mass to 30% by mass. The difference in refractive index between these particles and the polymer film of the invention is preferably 0 to 0.5. The examples of particles of inorganic materials include particles of silicon oxide, aluminum oxide and barium oxide. The examples of organic materials include acrylic resin, divinylbenzene resin, benzoguanamine resin, styrene resin, melamine resin, acryl-styrene resin, polycarbonate resin, polyethylene resin, and polyvinyl chloride resin. When inside light diffusibility is given to light transmitting property by particles, the value of inside haze is not restricted, but the value is preferably set so as not to make the reduction of all light transmittance excessively high by heightened backscattering. Specifically, inside haze by scattered particles is preferably 1% to 60%, and more preferably 3% to 50%.

### [Dope (Do)]

At least one dope different from the dope (Db) is a dope (Do) not substantially containing a dispersed phase that is phase-separated at the time of casting or in the process of eliminating the solvent after casting. The dope (Do) is cast to form a layer on the farthest side from the base material of the optical film at the time of casting the dope.

The dope (Do) is the same with the dope (Db) except that the dope (Do) does not substantially contain a dispersed phase that is phase-separated at the time of casting or in the process of eliminating the solvent after casting, and the same polymer, solvent and other additives as in the dope (Db) can be used. Since the dope (Do) does not substantially contain a dispersed phase, it is preferred not to contain a solvent having a dielectric constant of 35 or more. Further, the solvents contained in the mixed solvent in the dope (Do) are preferably completely compatible with each other. Specifically, the low dielectric constant solvent and medium dielectric constant solvent are preferably used as mixture, and the mass ratio of both is preferably 99/1 to 81/19, and more preferably 98/2 to 85/15.

### [Preparation of Dope]

A dope solution can be prepared with the preparing method of dope and apparatus used in an ordinary solvent cast method. As one example, a method containing a process of progressing dissolution of a polymer and additives, if necessary, in a solvent while swelling once at a low temperature (a swelling process), and a subsequent process of dissolving the polymer and the like under heat and pressure (a dissolving process) is exemplified.

In the swelling process, the temperature of the solvent is maintained at a low temperature of −10° C. to 39° C. or so. It is preferred that a part or the entire polymer is stirred to expedite dissolution of the polymer in the solvent at the time of swelling process. The swelling process is generally preferably performed for 0.1 hours to 6 hours or so.

Subsequently, in the dissolving process, the temperature of the solvent is raised to 40° C. to 240° C. or so and, at the same time, pressure is applied preferably at pressure of 0.2 MPa to 30 MPa or so, but not limitative, and the temperature and pressure are determined depending upon the kinds of the solute and solvent. The dissolving process is preferably performed for 0.1 hours to 6 hours or so.

In the next place, the obtained dope solution is made to a film. The film can be formed according to an ordinary solvent cast method. Specifically, the prepared polymer solution is cast on a drum or band, and the solvent is evaporated to form a film. The surface of the drum or band is preferably subjected to mirror finish. Doping according to the manufacturing method of the invention is carried out by co-casting of two or more layers. In doping by co-casting, a feed block method capable of easily adjusting the number of layers and a multi-manifold method excellent in thickness accuracy of each layer can be used, and a feed block method can be preferably used in the invention.

From the aspect of reducing streaky failure ascribing to contamination of a geeser at continuous manufacturing time, it is necessary for the dope (Db) to form a dispersed phase is used for a contiguous lower layer to a layer on the farthest side from the cast base material or a layer nearer to the base material than the contiguous lower layer. Foreign matters generated in the layer farthest from the cast base material at casting time have a great influence on the surface shape of the optical film.

When two layers are co-cast, the structure of Db/Do is taken in order of the cast base material side to the air side. In the case of three or more layers, each of Db and Do may be independently used in two or more layers. The composition of each Db and Do may be the same or different. When three or more layers are co-cast, the structure of Do/Db/Do, Db/Db/Do, and Db/Do/Do can be taken in order of the cast base material side to the air side.

From the viewpoint of the release from the surface of the drum or band, the dope Db according to the method of the invention is preferably used in a layer not directly being in contact with the cast base material. For preventing drawing up of air between the base material and the dope, the pressure between the bead and base material is generally reduced. Evaporation of solvent from the dope is liable to occur under reduced pressure, and an insoluble matter which causes streaky failure is easily adhered to the film. Accordingly, the dope Db is preferably used in a layer not directly being in contact with the cast base material. In addition, it is preferred that one of the dopes (Do) is cast at the time of casting the dope to form a layer nearest to the base material of the optical film.

The preferred constitution satisfying these conditions at the same time in the case of three-layer constitution is Do/Db/Do, and that in the case of four-layer constitution is Do/Do/Db/Do. In the above, when Do or Db is used in two or more layers, Do or Db may be a dope having the same composition, or may have different compositions.

The viscosity of the dope is preferably 1,000 cP to 50,000 cP, and more preferably 5,000 cP to 20,000 cP.

When the dope (Db) for forming a dispersed phase is used in forming the optical film of the invention, in particular for forming open voids on the surface of the optical film, the thickness of the dope layer (Do) not forming a dispersed phase which is the upper layer of the dope (Db) is preferably 10 μm or less and 0.1 μm or more, more preferably 5 μm or less and 0.2 μm or more, and most preferably 3 μm or less and 0.5 μm or more. Adhesion of an insoluble matter to the geeser can be controlled by the thickness in this range and it becomes possible for the dispersed phase formed by phase separation to form open voids on the surface of the optical film at the time of film forming.

When the dope Do is used in the layer nearest to the cast base material, the thickness of the dope layer is preferably 0.5 μm to 30 μm, more preferably 1 μm to 20 μm. Here, the thickness of the dope layer is a thickness supposing that a layer having a uniform thickness is formed from the dope after solvent evaporation by using the projected amount of the dope from the casting geeser and the area after film formation.

The thickness of the optical film in the invention is not especially restricted, but it is generally 20 μm to 200 μm or so, preferably 20 μm to 100 μm in the point of thinning, and more preferably 20 μm to 80 μm.

The concentration of the solid content of the dope for use in the layer nearest to the base material or the layer farthest from the base material is preferably lower by 0.1% by mass to 8.0% by mass than the concentration of the solid content of dope (Db) for forming a dispersed phase, and more preferably lower by 1.0% by mass to 5.0% by mass. By setting the concentration in this range, reduction of streaky failure and necessary surface shape are easily compatible.

### [Other Processes]

Concerning the casting and drying methods in the solvent cast method, the descriptions in the following patents can be adopted: JP-A-58-127737, JP-A-61-106628, JP-A-2-276830, JP-A-4-259511, JP-A-5-163301, JP-A-9-95544, JP-A-10-45950, JP-A-10-95854, JP-A-11-71463, JP-A-11-302388, JP-A-11-322946, JP-A-11-322947, JP-A-11-323017, JP-A-2000-53784, JP-A-2000-273184, JP-A-2000-273239, U.S. Pat. Nos. 2,336,310, 2,367,603, 2,492,078, 2,492,977, 2,492,978, 2,607,704, 2,739,069, 2,739,070, British Patents 640,731 and 736,892, JP-B-45-4554 (the term “JP-B” as used herein refers to an “examined Japanese patent publication”), JP-B-49-5614, JP-A-60-176834, JP-A-60-203430, and JP-A-62-115035.

The dope is cast on the base material such as a drum or a band at a surface temperature of preferably 10° C. or lower.

According to the method of the invention, it is preferred that a film is made with the dope on the base material and then subjected to drying after peeling. The residual solvent in the film is evaporated by the drying process. The film can be dried by blowing drying air. Drying may be performed in multistage by stepwise raising the temperature of drying air. The details of the casting process and drying process of solution-casting film-forming method are disclosed in JP-A-2005-104148, pp. 120 to 146 and these processes can be arbitrarily applied to the invention.

The polymer film formed can be used as an optical film as it is. Further, stretching treatment may be performed, if necessary, and further, haze may be adjusted. Stretching conditions are not especially restricted. Generally adopted conditions, for example, stretching temperature of (Tg−20) to (Tg+50)° C. or so and stretching magnification of 20 to 40% or so can be applied to the invention.

Stretching can be performed with roll stretching machine. Stretching may be longitudinal or transverse monoaxial stretching treatment or may be biaxial stretching treatment. In general, longitudinal monoaxial stretching treatment of stretching a long size film in the longitudinal direction is conducted.

It is preferred that the temperature of the base material is 20° C. or less so that the film is not subjected to leveling at initial stage of casting. It is also preferred that the temperature of the base material is 0° C. or less for cooling gelation purpose after casting.

### (Concavity)

The concavity of the optical film of the invention will be described below. In the specification of the invention, a concavity is the one having an average long axis length (Lb) of 0.5 μm to 100 μm.

The average long axis length (Lb) of the concavity of the optical film of the invention is 0.5 μm to 100 μm, preferably 1 μm to 50 μm, and more preferably 1 μm to 30 μm. In the specification of the invention, the long axis of a concavity is the longest size of diameters connecting the apertures of concavities (the ends of the cavity) formed on the surface of the optical film.

The depth of the concavity of the optical film of the invention is 5 μm or less, and 1 μm to 3 μm is more preferred in the point of high diffusibility. The depth of the cavity is the average value of the depths of all the concavities having the average long axis length of 0.5 μm to 100 μm on the surface of a sample film of a specific size.

From the standpoint of the adjustment of diffusibility, the average distance between two concavities of the above concavities is preferably 1 μm to 100 μm, and more preferably 1 μm to 50 μm. In the specification of the invention, the average distance between two concavities is a value obtained by measuring center-to-center distance to the nearest concavity of all concavities and dividing the sum total by the number of concavities.

In the specification of the invention, the depth of concavity, average long axis length and average distance are values computed from the surface shape measured with a surface shape measuring equipment. As the surface shape measuring equipment, a measuring equipment of a light interference system or a feeler type measuring equipment can be used. As the measuring equipment of a light interference system, a three-dimensional non-contact surface shape measuring system (Micromap MM5000 series, manufactured by Ryoka System K.K.) can be used. As the feeler type measuring equipment, a feeler type surface shape measuring equipment (Dektak 6M, manufactured by ULVAC ES) can be used. The distance from the surface of a flat part of the film to the deepest part of a concavity in each concavity can be automatically computed with such a surface shape measuring equipment. The depth of a concavity (that is, the average value of the depths of all concavities) can be computed by such measurement of all concavities.

The number of concavities on the film surface of the optical film of the invention is preferably 25 to 1,000,000/mm². The number of concavities of 100 to 100,000/mm² in the optical film is more preferred from the viewpoint of diffusibility and all light transmittance of a high value, and the number of 500 to 7,000/mm² is especially preferred.

### (Other Chemical Characteristics)

The haze of the optical film in the invention is preferably 3% or more, more preferably 30% or more, still more preferably 50% or more, and especially preferably 60% or more. The higher the haze, the higher is the light diffusing performance, but, on the other hand, all light transmittance is reduced by rising of haze, which causes reduction of frontal white luminance if such a film is used in an image display. From that point of view, the haze of the optical film in the invention is preferably 15% to 95%, more preferably 30% to 90%, and most preferably 50% to 90%.

Haze can be measured with a haze meter (NDH2000, manufactured by Nippon Denshoku Industries Co., Ltd.).

The all light transmittance of the optical film in the invention is preferably 70% or more, more preferably 75% to 95%, and especially preferably 80% to 93%. Further, the parallel transmittance of the optical film in the invention is preferably 5% to 55%, more preferably 8% to 40%, and especially preferably 10% to 40%. In the specification of the invention, all light transmittance means the transmittance of light of rays including linear light and diffused light, and parallel transmittance is the transmittance of light of rays including linear light alone.

When the optical film of the invention is used as the protective film of a polarizing plate in a closely contacting state with a polarizing film, from the standpoint of adhesion with the polarizing film, the optical film is especially preferably subjected to treatment to make the surface hydrophilic, such as acid treatment, alkali treatment, plasma treatment, or corona treatment.

### <Polarizing Plate>

### [Constitution of Polarizing Plate]

In a polarizing plate having a polarizing film and a protective film arranged on at least one side, the optical film of the invention can be used as the protective film. In manufacturing a polarizing plate with the optical film of the invention, by arranging the surface having concavities thereon on the surface side of the polarizing plate, the optical characteristics of the object of the invention can be obtained. Since the optical film of the invention doubles as the protective film, the manufacturing costs of the polarizing plate can be reduced. Further, by using the optical film of the invention on the surface of the backlight side, reconciliation of frontal contrast and reduction of moiré and luminance unevenness can be attained.

As the constitution of the polarizing plate, in the mode of arranging protective films on both sides of the polarizing film, the optical film of the invention is used as the protective film on one side and an ordinary cellulose acetate film may be used as the protective film on the other side, or a phase contrast film may be used as the protective film on the other side.

Further, in the polarizing plate of the invention, it is also a preferred embodiment that one side is the optical film of the invention and the other protective film is an optically compensatory film having an optically anisotropic layer comprising a liquid crystal compound.

### [Polarizing Film]

An iodine-based polarizing film, a dye-based polarizing film using a dichroic dye, and a polyene-based polarizing film are included in the polarizing film. The iodine-based polarizing film and a dye-based polarizing film can be manufactured generally with a polyvinyl alcohol film.

### [Optically Compensatory Film]

It is also preferred that, of two protective films of the polarizing film, a film other than the optical film in the invention is an optically compensatory film having an optically compensatory layer containing an optically anisotropic layer. The optically compensatory film (a phase contrast film) can improve characteristics of angle of visibility of the image plane of a liquid crystal display.

Well-known optically compensatory films can be used, but in view of widening the angle of visibility, the optically compensatory films disclosed in JP-A-2001-100042 are preferably used.

### <Use Mode in the Invention>

### [Image Display]

The optical film in the invention is preferably used in image displays such as a liquid crystal display (LCD), a plasma display panel (PDP), an electroluminescence display (ELD), and a cathode ray tube display (CRT).

### [Liquid Crystal Display]

The optical film and polarizing plate of the invention can be advantageously used in image displays such as a liquid crystal display and the like, and it is especially preferred to use them on the outermost surface layer on the backlight side of a liquid crystal cell in a transmission type and semi-transmission type liquid crystal displays.

In general, liquid crystal displays have a liquid crystal cell and two polarizing plates arranged on both sides of the liquid crystal cell, and the liquid crystal cell carries liquid crystal between two electrode substrates. Further, there are cases where one optically anisotropic layer is arranged between the liquid crystal cell and one polarizing plate, or two optically anisotropic layers are arranged between the liquid crystal cell and both polarizing plates.

Liquid crystal cell is preferably TN mode, VA mode, OCB mode, IPS mode or ECB mode.

### EXAMPLES

### Manufacture of Dope for Optical Film

Each dope is manufactured with the composition (parts by mass) shown in Table 1 below.

TABLE 1

| | | Dope Sample No. | | | | | | | |
|---|---|---|---|---|---|---|---|---|---|
| | | Db-1 | Db-2 | Db-3 | Db-4 | Db-5 | Db-6 | Db-7 | Db-8 |
| Composition of | Cellulose triacetate A | 90 | 90 | 90 | — | 100 | 90 | 90 | — |
| solid contents | Cellulose triacetate B | — | — | — | 90 | — | — | — | 90 |
| | Plasticizer A | 10 | 10 | 10 | 10 | — | — | 10 | 10 |
| | Plasticizer B | — | — | — | — | — | 10 | — | — |
| | Particles | — | — | — | — | — | — | — | — |
| Composition of | Dichloromethane | 91.5 | 90 | 60 | 90 | 90 | 90 | 95 | 70 |
| solvents | Methanol | 8 | 8 | 8 | 8 | 8 | 8 | — | 30 |
| | 1-Butanol | — | — | — | — | — | — | 3 | — |
| | Water | 0.5 | 2 | 32 | 2 | 2 | 2 | 2 | — |

| | | | | | | | | |
|---|---|---|---|---|---|---|---|---|
| Concentration of solid content (% by mass) | 18 | 18 | 18 | 18 | 18 | 18 | 15 | 18 |

| | | Dope Sample No. | | | | | |
|---|---|---|---|---|---|---|---|
| | | 101 | 102 | 103 | 104 | 105 | 106 |
| Composition of | Cellulose triacetate A | 90 | 89.9 | — | 99.9 | 89.9 | 90 |
| solid contents | Cellulose triacetate B | — | — | 89.9 | — | — | — |
| | Plasticizer A | 10 | 10 | 10 | — | — | 9.9 |
| | Plasticizer B | — | — | — | — | 10 | — |
| | Particles | — | 0.1 | 0.1 | 0.1 | 0.1 | 0.1 |
| Composition of | Dichloromethane | 92 | 92 | 92 | 92 | 92 | 97 |
| solvents | Methanol | 8 | 8 | 8 | 8 | 8 | — |
| | 1-Butanol | — | — | — | — | — | 3 |
| | Water | — | — | — | — | — | — |

| | | | | | | |
|---|---|---|---|---|---|---|
| Concentration of solid content (% by mass) | 18 | 16 | 16 | 16 | 16 | 15 |

The materials used are shown below.

Cellulose triacetate A: degree of acetyl substitution: 2.94, viscosity average polymerization degree: 300, degree of acetyl substitution on the 6-position is 0.94

Cellulose triacetate B: degree of acetyl substitution: 2.86, viscosity average polymerization degree: 310, degree of acetyl substitution on the 6-position is 0.89

Plasticizer A: Condensation product with ethane diol/adipic acid (1/1 by mol ratio) (number average molecular weight: 1,000)

Plasticizer B: Triphenyl phosphate

Particles: Primary particle size: 16 nm, AEROSIL R972 (manufactured by Nippon Aerosil Co., Ltd.)

Solvents: Dichloromethane (dielectric constant: 9), methanol (dielectric constant: 33), 1-butanol (dielectric constant: 17), and water (dielectric constant: 78),

In the following table: in dope (Db-03) the polymer is not dissolved and a homogeneous dope cannot be obtained. In dope (Db-01), haze is not present in the state before casting and a dispersed phase cannot be observed. With other dopes (Db-02), (Db-04) to (Db-08), a dispersed phase is formed by increasing the amount of water which is a solvent having a dielectric constant of 35 or more, and the haze of the dopes is 5 to 30%. The solvent of the dispersed phase comprises water and alcohol, and the polymer (cellulose triacetate) cannot be substantially dissolved in these solvents. The dope (D-01) is cast on a glass plate and surface state is visually observed with the evaporation of the solvent. The dope shows flowability and rising of haze is observed even in the state where the solvent remains, and formation of a dispersed phase is observed with the evaporation of dichloromethane of a low boiling temperature.

Dopes 101 to 106 are dopes not forming a dispersed phase.

Each of the thus-obtained dopes is heated at 30° C., and cast on a mirror-faced stainless steel base material having a band length of 60 m set at 15° C. through a casting geeser (refer to JP-A-11-314233). Casting speed is 50 m/min and coating width is 50 cm. Spatial temperature of the entire casting part is set at 15° C. The cast and turned film is peeled from the band at 50 cm before the finishing point of casting part and drying air at 45° C. is blown. The film is then dried at 110° C. for 5 minutes and at 140° C. for 10 minutes to obtain an optical film. Optical films (F-1) to (F-23) are manufactured by combining the dopes shown in Table 1 to obtain the structures shown in Table 2 below and casting. When two or more dopes are used, co-cast is performed according to the feed block method. The film thickness shown in the table is a conversion value supposing that the film having a uniform thickness is formed from the projected amount of the dope.

### [Evaluations of Optical Film]

The following evaluations are performed with each optical film.

### (1) Stability of Performance at Manufacturing Time

### [Streaky Unevenness of Film]

The surface of the optical film of the side opposite to the side of cast base material is visually observed by using the last 10 m of continuously formed 5,000 m of the film. A streaky unevenness generating from the specific place in the transverse direction to the casting direction is evaluated according to the following four grades.

A: Generation of streaky unevenness cannot be visually observed.
B: Streaky unevenness is slightly observed but on a practicable level.
C: Generation of streaky unevenness is observed.
D: Streaky unevenness is generated in high frequency.

### [Contamination of Drum]

Adhesion of a foreign matter is evaluated according to the following four grades by visually observing the surface of the casting drum at the point of time of 5,000 m from beginning of casting and after finishing film forming of continuous 10,000 m. The foreign matter is the adhered polymer dust.

A: Adhesion of a foreign matter on the casting drum is not observed at all.
B: Adhesion of a foreign matter on the casting drum is not observed but reflection of the mirror face is a little lowers.
C: Adhesion of a foreign matter on the casting drum is visually observed.
D: Adhesion of a foreign matter on the casting drum is visually observed in high frequency.

### (2) Characteristics of Optical Film

Concerning the physical properties of the concavities of the optical film, the depth, longer diameter and shorter diameter of the aperture of the concavity, center-to-center distance of concavities, and number of concavities are measured with a three-dimensional non-contact surface shape measuring system (Micromap MM5000 series, manufactured by Ryoka System K.K.).

As optical characteristics of the optical film, haze, all light transmittance and parallel transmittance are measured with a haze meter (NDH2000, manufactured by Nippon Denshoku Industries Co., Ltd.).

The results of evaluations are shown in the following Table 2.

TABLE 2

| | | | | | | | | | Stability of Performance at Film Forming Time | | |
|---|---|---|---|---|---|---|---|---|---|---|---|
| No. of | Doping Prescription | | | | | | | | Streaky | Contamination | Contamination |
| Optical | Cost Support Side ← → Air Side | | | | Film Thickness (μm) | | | | Unevenness | of Drum | of Drum |
| Film | L-1 | L-2 | L-3 | L-4 | L-1 | L-2 | L-3 | L-4 | of Film | (5,000 m) | (10,000 m) |
| F-1 | Db-01 | — | — | — | 60 | — | — | — | C | B | C |
| F-2 | Db-01 | 102 | — | — | 60 | 3 | — | — | A | B | C |
| F-3 | 102 | Db-01 | 102 | — | 3 | 60 | 3 | — | A | A | A |
| F-4 | Db-02 | — | — | — | 60 | — | — | — | D | B | D |
| F-5 | Db-02 | 102 | — | — | 60 | 3 | — | — | B | B | D |
| F-6 | 102 | Db-02 | 102 | — | 3 | 60 | 3 | — | A | A | A |
| F-7 | 102 | Db-02 | 102 | — | 3 | 60 | 10 | — | A | A | A |
| F-8 | 102 | Db-02 | 102 | — | 3 | 30 | 3 | — | A | A | A |
| F-9 | 102 | 101 | Db-02 | 102 | 3 | 30 | 30 | 3 | A | A | A |
| F-10 | Db-04 | — | — | — | 60 | — | — | — | D | B | D |
| F-11 | Db-04 | 103 | — | — | 60 | 3 | — | — | B | B | D |
| F-12 | 103 | Db-04 | 103 | — | 3 | 60 | 3 | — | A | A | A |
| F-13 | Db-5 | — | — | — | 60 | — | — | — | D | B | D |
| F-14 | Db-5 | 104 | — | — | 60 | 3 | — | — | B | B | D |
| F-15 | 104 | Db-5 | 104 | — | 3 | 60 | 3 | — | A | A | A |
| F-16 | Db-6 | — | — | — | 60 | — | — | — | D | B | D |
| F-17 | Db-6 | 105 | — | — | 60 | 3 | — | — | B | B | D |
| F-18 | 105 | Db-6 | 105 | — | 3 | 60 | 3 | — | A | A | A |
| F-19 | Db-7 | — | — | — | 60 | — | — | — | C | B | D |
| F-20 | 106 | Db-7 | 106 | — | 3 | 60 | 3 | — | A | A | A |
| F-21 | Db-8 | — | — | — | 60 | — | — | — | C | B | D |
| F-22 | 102 | Db-8 | 102 | — | 3 | 60 | — | — | A | A | A |
| F-23 | 102 | 101 | 102 | — | 3 | 60 | 3 | — | A | A | A |

| | Characteristics of Optical Film | | | | | | | | |
|---|---|---|---|---|---|---|---|---|---|
| | Physical Properties of Surface of Concavity | | | | | Optical Characteristics | | | |
| | | Longer | Shorter | Center-to- | Number | | All Light | Parallel | |
| No. of | | Diameter of | Diameter of | Center | of | | Transmit- | Transmit- | |
| Optical | Depth | Aperture | Aperture | Distance | Cavities | Haze | tance | tance | |
| Film | (μm) | (μm) | (μm) | (μm) | (/mm²) | (%) | (%) | (%) | Remarks |
| F-1 | 2.4 | 7.1 | 6.2 | 24 | 1,800 | 62 | 91 | 35 | Comparison |
| F-2 | 2.4 | 7.0 | 6.3 | 24 | 1,800 | 62 | 91 | 35 | Invention |
| F-3 | 2.4 | 7.0 | 6.3 | 24 | 1,800 | 62 | 91 | 35 | Invention |
| F-4 | 3.1 | 16.3 | 15.2 | 17 | 3,200 | 92 | 91 | 7 | Comparison |
| F-5 | 3.1 | 16.1 | 15.3 | 17 | 3,200 | 92 | 91 | 7 | Invention |
| F-6 | 3.1 | 16.1 | 15.3 | 17 | 3,200 | 92 | 91 | 7 | Invention |
| F-7 | 4.0 | 12.6 | 12.2 | 17 | 3,200 | 92 | 88 | 7 | Invention |
| F-8 | 3.0 | 16.0 | 15.3 | 22 | 2,100 | 87 | 91 | 12 | Invention |
| F-9 | 3.0 | 16.0 | 15.3 | 22 | 2,100 | 87 | 91 | 12 | Invention |
| F-10 | 3.2 | 14.5 | 14.0 | 17 | 3,200 | 92 | 91 | 7 | Comparison |
| F-11 | 3.2 | 14.4 | 14.1 | 17 | 3,200 | 92 | 91 | 7 | Invention |
| F-12 | 3.2 | 14.4 | 14.1 | 17 | 3,200 | 92 | 91 | 7 | Invention |
| F-13 | 3.2 | 14.7 | 13.9 | 16.5 | 3,400 | 92 | 90 | 7 | Comparison |
| F-14 | 3.2 | 14.4 | 14.1 | 17 | 3,200 | 92 | 90 | 7 | Invention |
| F-15 | 3.2 | 14.4 | 14.1 | 17 | 3,200 | 92 | 90 | 7 | Invention |
| F-16 | 3.2 | 14.5 | 14.0 | 17 | 3,300 | 92 | 91 | 7 | Comparison |
| F-17 | 3.2 | 14.3 | 14.1 | 17 | 3,200 | 92 | 91 | 7 | Invention |
| F-18 | 3.2 | 14.3 | 14.1 | 17 | 3,200 | 92 | 91 | 7 | Invention |
| F-19 | 1.2 | 3.2 | 3.1 | 45 | 500 | 25 | 91 | 68 | Comparison |
| F-20 | 1.2 | 3.2 | 3.1 | 45 | 500 | 25 | 91 | 68 | Invention |
| F-21 | 0.6 | 1.2 | 1.0 | 11 | 9,900 | 80 | 82 | 16 | Comparison |
| F-22 | 0.5 | 1.1 | 1.0 | 10 | 9,700 | 80 | 82 | 16 | Invention |
| F-23 | — | — | — | — | — | 0 | 93 | 93 | Comparison |

From the results shown in Table 2, it can be seen that the optical films manufactured according to the manufacturing method of the invention are excellent in stability at film forming time, and have good light scattering properties, that is, high in haze, all light transmittance and forward scattering.

In particular, although film is formed by co-casting the dope (Do) not containing the dispersed phase on the dope (Db) for forming the dispersed phase, where the polymer is substantially insoluble, it is unexpected at all that the dispersed phase has moved to the outermost surface of the optical film after evaporation of the solvent and open voids are formed.

In the obtained optical films (F-1) to (F-20), the shape of the apertures of the concavities observed from the direction vertical to the film surface is almost circular and the equivalent-circle diameter (equivalent-circle diameter of the projected area) is in the range of about 5 μm to about 16 μM. Similarly, the shape of the bottom of concavities observed from the direction vertical to the film surface is almost circular and the equivalent-circle diameter (equivalent-circle diameter of the projected area) is in the range of about 3 μm to about 10 μm. Further, the details of cross sections in the film thickness direction in these optical films other than those described in Table 2 are as follows: the bottom of the concavity is formed in the width of 60% to 70% when the width of the entire cavity is taken as 100%, the inclination of the face of cavity bottom to the film surface is within ±2.5°, and the radius of curvature becomes gradually smaller from the bottom of concavity to the end of concavity. The void ratio of each of the inside cavities of these films is 1% or less (volume ratio).

### [Evaluation Using Liquid Crystal Display]

Note-type PC(R700-XP50K, number of pixels: 1,440×900, 17 inches, manufactured by LG Display) is disassembled and the light diffusion sheet contiguous to the polarizing plate on the backlight side is taken out, the protective film of the polarizing plate on the backlight side adhered to the liquid crystal cell is peeled, and the optical film is adhered in place as shown in Table 3 below.

The following evaluations are performed with each of the thus-manufactured liquid crystal displays.

### (1) Frontal White Luminance

Signals are input to the manufactured liquid crystal display through a video signal generator (VG-848, manufactured by Astro Design), white display of 256/256 gradation of entire solid display, and luminance is measured in a dark room from the direction of normal line (front) of flat surface of the liquid crystal display with a luminance meter (BM5-A, manufactured by Topcon Corporation). Five points in total of each one point on up and down sides and each one point of the left and right sides from three points of the center of the image plane with intervals of 3 cm, and the average value is computed. Evaluation is performed by the following three grades with the case where optical film (F-23) not having a light scattering property on the surface of the polarizing plate on the backlight side being standard.

A: Reduction is hardly observed (98% to 100% of standard value)
B: Reduction is observed a little (95% to less than 98% of standard value)
C: Reduction is observed (less than 95% of standard value)
(2) Moiré

Signals are input to the manufactured liquid crystal display through a video signal generator (VG-848, manufactured by Astro Design), gray display of 128/256 gradation of entire solid display, and the image plane is visually observed from various directions in a dark room and presence or absence of moiré is evaluated.

A: Moiré is not observed.
B: Moiré is slightly observed but hardly displeasing.
C: Moiré is observed and a little displeasing.
D: Moiré is clearly observed.

As the level of moiré, grade B or higher is practicably necessary.

The results of evaluations are shown in the following Table 3.

TABLE 3

| No. of | No. of | Frontal | | |
|---|---|---|---|---|
| Display | Optical Film | Luminance | Moiré | Remarks |
| LCD-1 | F-2 | A | A | Invention |
| LCD-2 | F-3 | A | A | Invention |
| LCD-3 | F-5 | A | A | Invention |
| LCD-4 | F-6 | A | A | Invention |
| LCD-5 | F-7 | B | A | Invention |
| LCD-6 | F-8 | A | A | Invention |
| LCD-7 | F-9 | A | A | Invention |
| LCD-8 | F-11 | A | A | Invention |
| LCD-9 | F-12 | A | A | Invention |
| LCD-10 | F-14 | B | A | Invention |
| LCD-11 | F-15 | B | A | Invention |
| LCD-12 | F-17 | A | A | Invention |
| LCD-13 | F-18 | A | A | Invention |
| LCD-14 | F-20 | A | B | Invention |
| LCD-15 | F-22 | C | A | Invention |
| LCD-16 | F-23 | A | D | Comparison |

From the results shown in Table 3, it can be seen that the optical film of the invention shows high frontal luminance, generation of moiré is prevented, and it can be seen that light diffusion sheet contiguous to the polarizing plate on the backlight side can be removed when the optical film is used on the backlight side of the liquid crystal display.

1. A method for manufacturing an optical film, comprising: casting two or more dopes on a base material simultaneously, each dopes containing at least a polymer and a solvent; and eliminating the solvent,
wherein
at least one dope is a dope (Db) that already contains a dispersed phase at a time of the casting or that forms a phase-separated dispersed phase in the eliminating the solvent after the casting;
the dope (Db) contains a main component of the solvent constituting the dispersed phase, the main component being a solvent in which the polymer is substantially insoluble;
the dope (Db) is cast to form a contiguous lower layer to a layer on the farthest side from the base material of the optical film or a layer nearer to the base material than the contiguous lower layer, at the time of the casting;
at least one dope different from the dope (Db) is a dope (Do) not substantially containing a dispersed phase that is phase-separated at the time of the casting or in the eliminating the solvent after the casting, and
the dope (Do) not substantially containing a dispersed phase is cast to form a layer on the farthest side from the base material of the optical film at the time of the casting.

2. The method for manufacturing an optical film as claimed in claim 1, wherein the dope (Do) not substantially containing a dispersed phase is cast at the time of the casting to form a layer nearest to the base material of the optical film.

3. The method for manufacturing an optical film as claimed in claim 1, wherein the solvent contained in at least one of the dope (Db) is a mixed solvent containing two or more solvents and at least one solvent of the two or more solvents has a dielectric constant of 35 or more, and at least two solvents of the mixed solvent are solvents hardly compatible with each other.

4. The method for manufacturing an optical film as claimed in claim 3, wherein the mixed solvent contained in at least one of the dope (Db) is a mixed solvent containing a solvent having a dielectric constant of 35 or more in an amount of from 0.3% by mass to 30% by mass.

5. The method for manufacturing an optical film as claimed in claim 3, wherein the mixed solvent contained in at least one of the dope (Db) contains a solvent having a dielectric constant of 2 or more and less than 10, and a solvent having a dielectric constant of 10 or more and less than 35.

6. The method for manufacturing an optical film as claimed in claim 3, wherein the solvent having a dielectric constant of 35 or more is water.

7. The method for manufacturing an optical film as claimed in claim 1, wherein the solvent contained in at least one of the dope (Db) is a mixed solvent containing two or more solvents and at least one solvent of the two or more solvents has a dielectric constant of 2 or more and less than 10, and at least other one solvent has a dielectric constant of 10 or more and less than 35.

8. The method for manufacturing an optical film as claimed in claim 1, wherein the polymer contained in at least one of the dope (Db) is cellulose acylate.

9. An optical film manufactured by a manufacturing method comprising:
casting two or more dopes on a base material simultaneously, each dopes containing at least a polymer and a solvent; and eliminating the solvent,
wherein
at least one dope is a dope (Db) that already contains a dispersed phase at a time of the casting or that forms a phase-separated dispersed phase in the eliminating the solvent after the casting;
the dope (Db) contains a main component of the solvent constituting the dispersed phase, the main component being a solvent in which the polymer is substantially insoluble;
the dope (Db) is cast to form a contiguous lower layer to a layer on the farthest side from the base material of the optical film or a layer nearer to the base material than the contiguous lower layer, at the time of the casting;
at least one dope different from the dope (Db) is a dope (Do) not substantially containing a dispersed phase that is phase-separated at the time of the casting or in the eliminating the solvent after the casting, and
the dope (Do) not substantially containing a dispersed phase is cast to form a layer on the farthest side from the base material of the optical film at the time of the casting.

10. The optical film as claimed in claim 9, which has a haze of 3% or more and 95% or less.

11. A polarizing plate comprising a polarizing film and two protective films on both sides of the polarizing film, wherein at least one of the protective films is an optical film manufactured by a manufacturing method comprising:
casting two or more dopes on a base material simultaneously, each dopes containing at least a polymer and a solvent; and eliminating the solvent,
wherein
at least one dope is a dope (Db) that already contains a dispersed phase at a time of the casting or that forms a phase-separated dispersed phase in the eliminating the solvent after the casting;
the dope (Db) contains a main component of the solvent constituting the dispersed phase, the main component being a solvent in which the polymer is substantially insoluble;
the dope (Db) is cast to form a contiguous lower layer to a layer on the farthest side from the base material of the optical film or a layer nearer to the base material than the contiguous lower layer, at the time of the casting;
at least one dope different from the dope (Db) is a dope (Do) not substantially containing a dispersed phase that is phase-separated at the time of the casting or in the eliminating the solvent after the casting, and
the dope (Do) not substantially containing a dispersed phase is cast to form a layer on the farthest side from the base material of the optical film at the time of the casting.

12. An image display having an optical film 9 manufactured by a manufacturing method comprising:
casting two or more dopes on a base material simultaneously, each dopes containing at least a polymer and a solvent; and eliminating the solvent,
wherein
at least one dope is a dope (Db) that already contains a dispersed phase at a time of the casting or that forms a phase-separated dispersed phase in the eliminating the solvent after the casting;
the dope (Db) contains a main component of the solvent constituting the dispersed phase, the main component being a solvent in which the polymer is substantially insoluble;
the dope (Db) is cast to form a contiguous lower layer to a layer on the farthest side from the base material of the optical film or a layer nearer to the base material than the contiguous lower layer, at the time of the casting;
at least one dope different from the dope (Db) is a dope (Do) not substantially containing a dispersed phase that is phase-separated at the time of the casting or in the eliminating the solvent after the casting, and
the dope (Do) not substantially containing a dispersed phase is cast to form a layer on the farthest side from the base material of the optical film at the time of the casting.
